(19) United States
(12) Patent Application Publication
(10) Pub. No.: US 2005/0183559 A1
(43) Pub. Date: Aug. 25, 2005

(54) Reciprocating table saw

(76) Inventor: Jerry Randall Rue, Mansfield, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 10/782,307

(22) Filed: Feb. 19, 2004

(51) Int. Cl. B26D 5/00

(52) U.S. Cl. 83/574; 83/821; 83/859

(57) ABSTRACT

There is disclosed a powered reciprocating table saw, for sawing large foam panels having embedded steel framing members, comprising a work table for supporting a workpiece on a top side of the work table and having a blade opening disposed through the work table proximate a central portion thereof. A saw motor is supported underneath the work table, the saw motor having a reciprocating output shaft extending from a housing of the motor, and blade clamping means disposed on the output shaft. An elongated saw blade is retained in the blade clamping means of the saw motor and positioned to move reciprocatingly through the blade opening to the top side of the work table for sawing the workpiece. In another aspect a motor mount is disclosed for attaching the saw motor to the work table. In yet another aspect a blade guide supported by the work table is disclosed, which limits sideways and rearward displacement of the saw blade while sawing the workpiece.

### BACKGROUND OF THE INVENTION

1. Field of the Invention

The present invention generally relates to power tools and, more particularly, to motor driven saws.

2. Description of the Prior Art

Construction of residential and small business buildings has traditionally utilized wood framing and fiberglass or rock wool insulation to provide insulated walls, ceilings and roofs for the buildings. Newer materials and methods providing improved energy efficiency are replacing the fiberglass or rock wool insulation materials with foam products such as foam-in-place polyurethane or rigid panels fabricated from polystyrene. One type of panel, available from companies such as ThermaSteel, of Radford, Va. or Techbuilt Manufacturing, of Cleveland, Ohio, is constructed of molded polystyrene with steel framing members integrated within the panels during molding These foam/steel panels are available in various sizes, typically 2′×8,′ 4′×8′ or larger, and in thicknesses from 3-½″ to 7-½,″ with R-values of, e.g., R30 for a 7-½″ thick panel. The panels are strong enough to support the loads encountered in one and two story buildings. Energy savings for heating and cooling may exceed 50% compared with traditional construction.

In the prior art, foam panels of insulation may be cut using hand saws or powered saws. However, hand saws are slow, labor intensive and not well-suited to construction site uses. While powered saws are faster, circular saws do not have the ability to cut to a precise depth completely through a panel and reciprocating saws, while useful for making small cuts or blind cuts, are not suited for making long, accurate cuts in large panels. A powered hacksaw is well adapted to cutting metal bar stock but not large panels without building a custom-made unit, which would be cost-prohibitive. A band saw, though it has the ability to cut foam or steel, is limited in throat size such that it would also be prohibitively large and expensive to purchase, set up and use at a typical construction site.

Another type of device found in the prior art forces a wire, heated or under tension, through the foam material, as disclosed in U.S. Pat. No. 4,608,893 to Huhne, U.S. Pat. No. 5,666,872 to McDonald et al., and U.S. Pat. No. 6,575,070 to Peyeri et al. Each of these uses a continuous wire that is moved through the foam either continuously (McDonald et al. Or Peyeri et al.) Or by reciprocating action (Huhne). However, none of these devices are able to cut foam panels that have steel framing members embedded in the foam material.

What is needed is a powered table saw with the precision of a band saw, the low cost of a simple circular table saw, which can make long rip cuts or short trim cuts in foam/steel panels with equal ease and accuracy and which is configured as a light-weight device that may be easily carried by one person and set up rapidly at a construction site using a minimum of tools.

### SUMMARY OF THE INVENTION

Accordingly, there is disclosed a powered reciprocating table saw, comprising a work table, having first and second sides, for supporting a workpiece on the first side of the work table and having a blade opening disposed through the work table proximate a central portion thereof; a saw motor supported from the second side of the work table, the saw motor having a housing, a reciprocating output shaft extending from the housing, and blade clamping means disposed on the distal end of the reciprocating output shaft; and an elongated saw blade having first and second ends, retained at the first end in the blade clamping means of the saw motor and positioned to pass through and move reciprocatingly along an axis of reciprocation within the blade opening of the work table wherein the saw blade extends substantially beyond the first side of the work table for cutting the workpiece during operation.

In another aspect there is disclosed a motor mount for attaching between the saw motor housing and the second side of the work table to support the saw motor from the second side of the work table wherein the axis of reciprocation of the output shaft is aligned with the blade opening in the work table and disposed approximately orthogonal to the work table.

In yet another aspect there is disclosed a blade guide supported by the work table and disposed away from the first side of the work table adjacent the axis of reciprocation and embracing the second end of the saw blade to limit sideways displacement of the second end of the saw blade relative to the axis of reciprocation while cutting the workpiece. The blade guide may be supported by a cantilevered support arm extending from a side of the work table. Alternatively, the blade guide may be supported by a non-cutting blade member disposed rearward of the cutting blade and in the same plane as the cutting blade such that the non-cutting blade occupies the kerf formed by the cutting blade. In yet another aspect the non-cutting blade member may be used as a damping strap to damp vibratory motion of the cantilevered support arm.

### BRIEF DESCRIPTION OF THE DRAWINGS

FIG. 1 illustrates a pictorial view of one embodiment of a powered reciprocating table saw according to the disclosed invention, prepared to receive a foam/steel panel workpiece;

FIG. 2 illustrates a pictorial view of a saw motor mounting structure for use with the embodiment of the powered reciprocating table saw of FIG. 1;

FIG. 3 illustrates a side pictorial view of details of the saw motor and saw blade mounting structure of the embodiment of the powered reciprocating table saw of FIG. 1;

FIG. 4 illustrates a pictorial view of details of one embodiment of a saw blade guide assembly including a guide block assembly and a cantilevered support arm stabilized by a damper strap for use with the embodiment of the powered reciprocating table saw of FIG. 1;

FIG. 5 illustrates a top plan view of one embodiment of a guide block assembly for use with the embodiment of the powered reciprocating table saw of FIG. 4;

FIG. 6 illustrates a side view of a cross section of a corner of a work table of the embodiment of the powered reciprocating table saw of FIG. 1 showing detail of one embodiment of a folding leg assembly with the leg in an extended position for supporting the work table; and

FIG. 7 illustrates the folding leg of FIG. 6 in a folded position against the work table for transporting the embodiment of the powered reciprocating table saw of FIG. 1.

### DETAILED DESCRIPTION OF THE INVENTION

The powered reciprocating table saw of the present invention, while designed for cutting large foam/steel insulated building panels, embodies a versatility beyond that particular application because it functions much like a large band saw having the capacity for sawing large work pieces, and it may be used as a table saw that can saw curved cuts in a wide variety of materials. Unlike a conventional band saw, it is designed to be portable and easily set up on a work site. A pilot hole is not required as is necessary with a band saw when making inside cuts. It is safer to use than a table saw because the blade does not tend to pull the work piece into the blade. Although the preferred embodiment is constructed of aluminum for light weight, it is easy to construct from a variety of materials, and may be configured with folding legs or supported on saw horses at the work site. It will also be appreciated that the invention is not limited to a particular brand or type of reciprocating saw motor, or to a particular combination of features to satisfy specific needs.

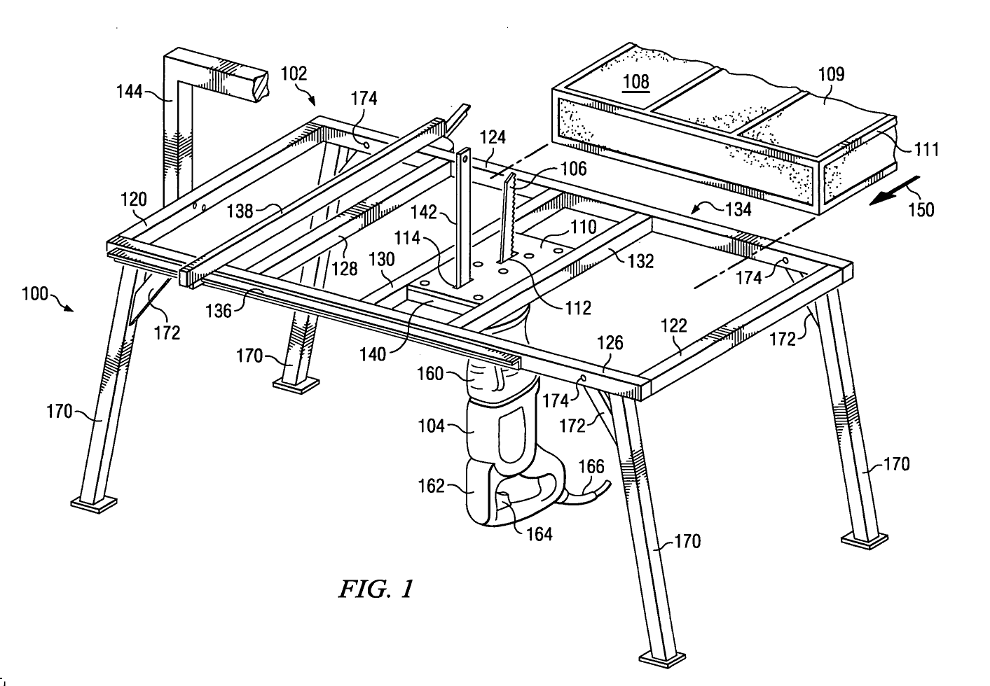

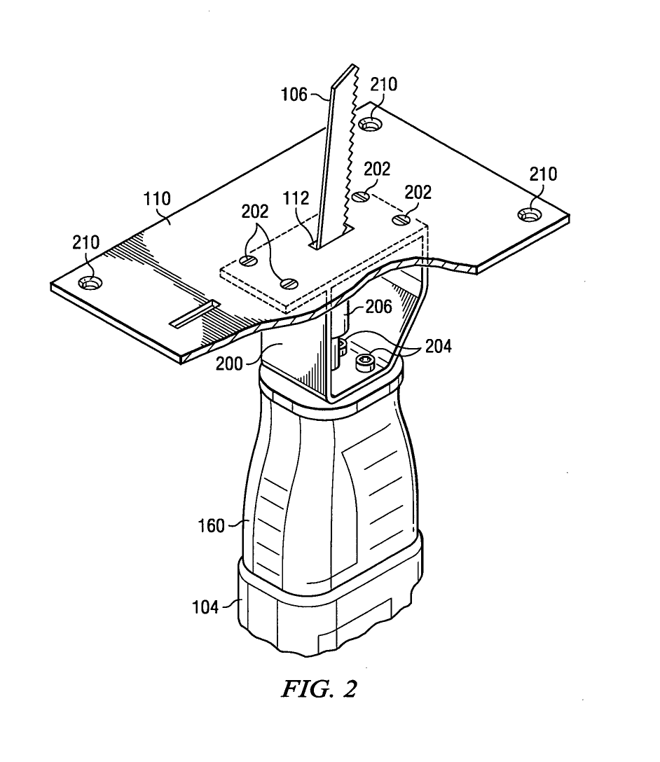

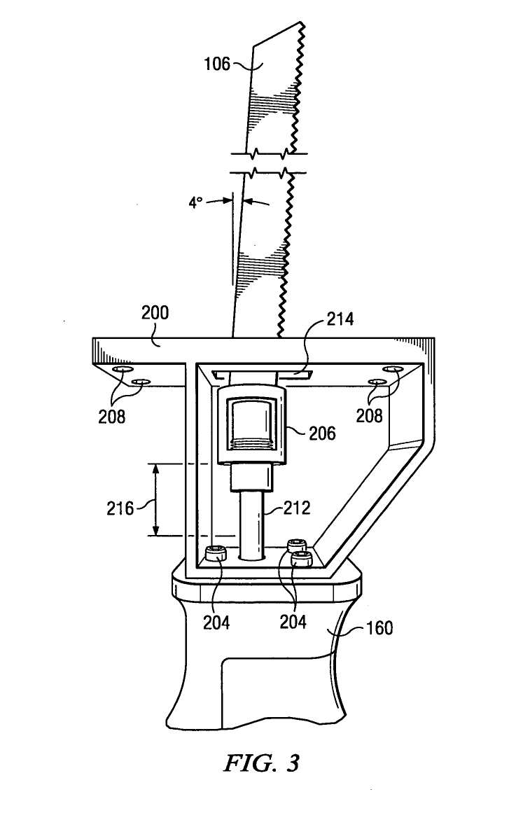

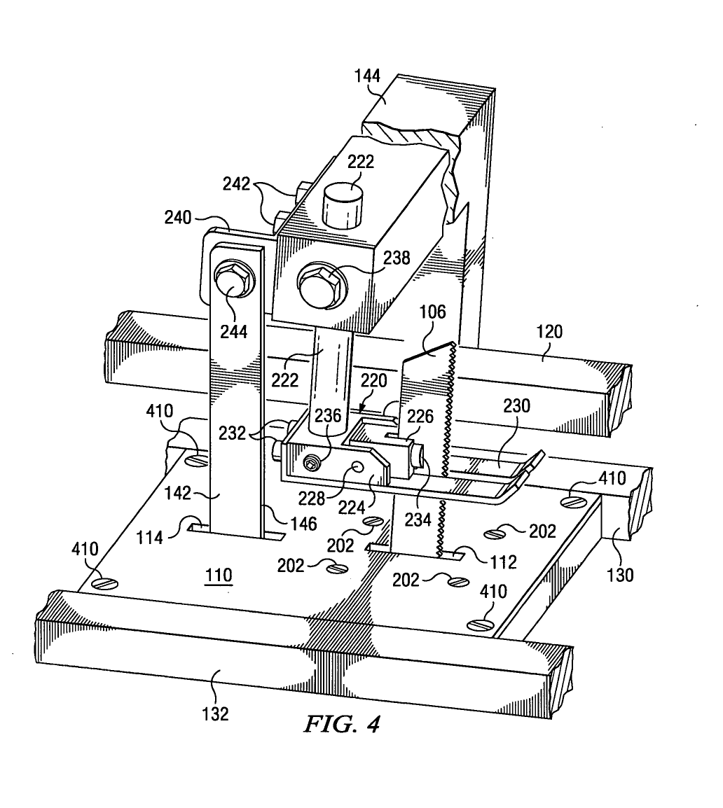

Referring to FIG. 1, there is illustrated a pictorial view of one embodiment of a powered reciprocating table saw 100 according to the disclosed invention. In the figure, the table saw 100 is shown prepared to receive a foam/steel panel workpiece 108 being fed toward the table saw 100 in the direction 150. The table saw 100 includes a work table frame 102 and a top mounting plate 110 that is centrally positioned between a pair of intermediate cross members 130, 132 of the work table frame 102. A saw motor 104 having an elongated saw blade 106 is mounted vertically oriented to the underside of the mounting plate 110 such that the elongated blade 106 extends upward through a blade opening 112 in the mounting plate 110. The saw motor 104 is attached to the underside of the mounting plate 110 by a motor mount 200 (shown in FIGS. 2 and 3) A blade guide assembly 224 et seq. (see FIG. 4) is suspended above the work table 102 and the workpiece 108 during operation of the saw. The blade guide assembly maintains the upper, free end of the elongated saw blade 106 in a stable position, preventing sideways or rearward displacement of the saw blade 106 during a cutting operation.

The work table frame 102 is a ladder-type frame constructed of a pair of parallel side rails, near side rail 124 and far side rail 126, which are joined by a plurality of parallel cross members attached to the side rails at right angles. The reader will note that the terms near and far (as regards the side rails 124, 126) are from the perspective of an operator standing behind the reciprocating table saw 100 while guiding the work piece 108 toward the elongated saw blade 106 during operation. The parallel cross members include a right main and a left main cross members 120 and 122, located at the ends of the work table frame 102. Several parallel intermediate cross members, 128, 130 and 132 are shown connected between the side rails 124, 126 at locations along the side rails 124, 126 intermediate between the main cross members 120, 122. In the embodiment shown in FIG. 1, the intermediate cross members 130, 132 are located approximately half-way between the ends of the work table frame and define a central portion of the work table frame where the saw motor 104 is located.

Continuing with FIG. 1, the mounting plate 110 is supported on two mounting plate support members 140 supporting opposite edges of the mounting plate 110 (only one of them is shown in the figure) The support members 140 are connected between the parallel intermediate cross members 130, 132 so that the upper surface of the mounting plate 110 is in the same plane as the upper surface of the work table frame. The mounting plate 110 includes an elongated saw blade opening 112 for passage of the elongated saw blade 106 and a second elongated opening 114 for passage of a damper strap 142 for stabilizing the blade guide assembly to be described herein below. Attached to the outer side of each of the side rails 124, 126 are respective tracks, 134, 136 for supporting a table saw fence 138. The track 134 is not shown in the FIG. 1 because it is located out of sight behind the near side rail 124 in the figure. As is well known, a table saw fence 138 provides an adjustable barrier for guiding the workpiece through the saw blade to ensure a straight cut.

While the work table frame may be supported on saw horses or other temporary leg substitutes, the illustrative embodiment includes folding legs 170 at each corner of the work table frame 102, extended as shown in the figure. The folding legs 170 may also be fabricated of rectangular or square section aluminum tubing. Each of the folding legs 170 pivot on a pivot pin 174 to move between a collapsed position and an extended position. A pivot bushing 176 (see FIGS. 6 and 7) for each leg 170 is located at an upper end of a rigid brace 172 attached to the leg 170, the opposite end of the brace being fixedly attached to the leg 170 at an acute angle, typically about 30 degrees. However, this angle the brace 172 makes with the leg 170 may be varied to suit the particular application. The upper end of the leg 170, which is not visible in the drawing because of the perspective employed, is not attached to the respective side rail but is instead held against the side rail by a latching mechanism as will be described in detail herein below in conjunction with FIGS. 6 and 7. The system of folding legs shown in the embodiment of FIG. 1 provides a sturdy yet light weight construction provided for ease of carrying and set up at a job site.

Continuing with FIG. 1, the saw motor 104 in the illustrated embodiment, shown somewhat enlarged in relation to the work table frame 102 for clarity, may be any of several readily available conventional reciprocating saws. One saw successfully adapted to the present invention is a Model DW303M VS Reciprocating Saw manufactured by the DeWalt Industrial Tool Company, 701 East Jappa Road, Baltimore, Md. 21286. This saw has a stroke of approximately 3/4 inch. Some other features of reciprocating saws of this type that may be useful in this application include a variable speed motor, a control of the blade motion, e.g., reciprocating or orbital, and a spring-loaded lever blade release for releasing the saw blade 106 from the chuck (see the blade clamp assembly 206 in FIG. 3). A chuck or blade clamp assembly holds the saw blade 106 to the reciprocating output shaft 212. The saw motor should be rated at least 6.5 Amperes for light duty cutting. For heavy duty or prolonged uses, the saw motor should preferably be rated at 12 to 15 Amperes. Higher rated saw motors may be used if the circuit used to supply the electrical power is rated for the additional amperage. In the present application, a cage-like blade guard of the DeWalt model identified herein above is modified to function as a motor mount to mount the saw motor 104 upon the underside of the mounting plate 110. The mounting of the saw motor will be described in detail herein below in conjunction with FIGS. 2 and 3. Other brands besides the DeWalt company that manufacture reciprocating saws with similar capabilities and ratings should be suitable. For example, a reciprocating saw manufactured by the Milwaukee company has a chuck for holding the saw blade that has a blade release collar that is rotated under spring tension to release the saw blade from the chuck.

The saw motor 104 includes a housing 160 that encloses a saw motor transmission (not visible in FIG. 1). The saw motor transmission is a mechanism that converts the rotary motion of the drive shaft of the saw motor 104 to the reciprocating, back-and-forth motion of the reciprocating output shaft 212 (see FIG. 4). For good results, the stroke 216 (see FIG. 3) of the reciprocating motion should be at least one-half inch and can be as much as 1-½ to 2 inches. The saw motor includes a handle 162, a trigger switch 164 and a power cord 166. The power cord 166 may be stored on a spool (not shown) or other bracket (not shown) mounted upon the work table frame. In a preferred embodiment, the trigger switch 164 is removed and replaced with a power ON/OFF switch located on the work table frame 102 in a convenient location that can be safely reached by the operator of the reciprocating table saw. Alternatively, the ON/OFF switch may be implemented as a foot switch connected to the saw motor 104. Such rewiring of the power supply and ON/OFF switch to the saw motor 104 is well within the skills of a qualified electrician. In another alternate embodiment, the saw motor may be configured to operate at several different speeds, either as a built-in feature or by using a variable speed control.

In an alternate embodiment, the saw motor assembly may be a custom design, for example combining the motor, the transmission, the motor mount and the blade clamping device in a single compact unit. A compact saw motor assembly (not shown) would place the center of mass of the saw motor assembly closer to the underside of the mounting plate, thus reducing the moment arm associated with the motions of the moving parts of the saw motor assembly. The result would be less vibration and improved stability of the reciprocating table saw. A compact saw motor assembly would also be amenable to the use of a quick-release mounting device to enable installing or changing the saw motor assembly without the use of tools.

FIG. 1 also includes several other structures that will be described in detail herein below. A damper strap 142, shown extending upward from an elongated slot 114 in the mounting plate 110, is disposed in the same plane as the elongated saw blade 106. The damper strap 142 will occupy the kerf in the workpiece 108 produced by the elongated saw blade 106 during cutting of the workpiece 108A support arm 144 attached to the right main cross-member 120 extends upward and over the work table frame 102 in cantilever fashion. The support arm 144, truncated in FIG. 1 so as not to obscure other structures of principle interest in the figure, will be further described in conjunction with FIG. 4. The damper strap 142 is provided to stabilize the cantilevered end of the support arm 144.

The components of the work table frame 102 illustrated in FIG. 1 and described herein above may be assembled with fasteners such as machine screws or by welding the components together. The preferred material is aluminum because of its light weight. Steel is suitable but heavier and increases the difficulty for one person to carry and maneuver the complete reciprocating table saw on a job site. In the illustrative embodiment, the side rails and cross members may be fabricated from two inch, square-section aluminum bar stock. This material provides a strong frame for the work table that is light-weight and may be carried by one person to a job site. In an alternate embodiment, the work table frame 102 may be covered with a thin, rigid sheet covering (not shown) of metal, plastic or wood or other suitable material to enhance the usability of the work table as a work surface. Such a covering may be approximately 0.090 inches to 0.125 inches thick and secured to the work table frame 102 and provided with a saw blade opening 112.

The work piece 108 shown in FIG. 1 depicts one end of a 4′×8′×7-½″ foam/steel panel of the type that may be readily cut and trimmed using the powered reciprocating table saw of the present invention. The foam/steel panels are typically molded of expanded polystyrene (EPS), a rigid foam product, and are manufactured with galvanized sheet steel, pre-formed framing members integrally molded as part of the panel. The sheet steel used to construct the structural elements of the panels may be in the range of thicknesses from 24 ga To 18 ga. The panels may be manufactured in lengths of 8 to 12 feet, widths of 2 to 4 feet, and thicknesses of 3-½ to 11-½ inches. Some versions, even without requiring extra support, may be configured to support loads of up to three floors. Use of the foam/steel panels greatly reduces construction cost because of the simplicity of their use and the ease with which the panels may be cut and trimmed to fit, especially when using the reciprocating table saw of the present invention. Similarly, the excellent insulating properties of the expanded polystyrene foam greatly reduces utility costs for the building owner. For example, a 7-½ thick panel has an R30 insulation rating. The foam/steel panels described herein are manufactured by ThermaSteel Corporation, with plants in Virginia, California and several foreign countries, and by Techbuilt Manufacturing, Inc. of Cleveland, Ohio.

Referring to FIG. 2, there is illustrated a close up pictorial view of a saw motor mounting structure for use with the embodiment of the powered reciprocating table saw of FIG. 1. Some of the structures illustrated in FIG. 2 appeared in FIG. 1 and bear the same reference numbers. In FIG. 2, the saw motor 104, having a saw motor housing 160 that encloses the saw motor transmission, is attached to the mounting plate 110 by a motor mount 200 using four motor mount screws 202. The motor mount 200 attaches to the saw motor housing 160 using three saw motor screws, 204, of which only two appear in the view presented in FIG. 2. The third saw motor screw is hidden between the near side of the motor mount 200 and the blade clamp assembly 206. The blade clamp assembly 206, also called a chuck, is located on the upper end of the reciprocating output shaft 212 (see FIG. 3) and is used to couple the elongated saw blade 106 to the reciprocating output shaft 212. As previously described, the elongated saw blade 106 extends upward through the elongated opening 112 in the mounting plate 110. The mounting plate 110 is attachable to the mounting plate support bars 140 (see FIG. 1) between the intermediate cross members 130, 132 by machine screws installed through the mounting plate holes 210.

Referring to FIG. 3, there is illustrated a side view of details of the saw motor and saw blade mounting structure of the embodiment of the powered reciprocating table saw of FIG. 1. Some of the structures illustrated in FIG. 2 appeared in FIG. 1 and bear the same reference numbers. In FIG. 3, the saw motor housing 160 is shown attached to the motor mount 200 by the saw motor screws 204. In this view, all three of the saw motor screws 204 that attach the motor mount 200 to the saw motor housing 160 may be seen. The motor mount 200 further includes four tapped holes 208 for attaching the motor mount 200 to the underside of the mounting plate 110 using machine screws having threads that match the threads tapped into the holes 208. The motor mount 200 also includes a saw blade slot 214 through which extends the elongated saw blade 106. The motor mount 200, which may be fabricated of a rigid, high-strength material such as steel or aluminum, may be cast or welded to provide the configuration shown. The motor mount 200 may be equipped with wedge-shaped shims for varying the angle that the elongated saw blade 106 makes as it emerges from the mounting plate 110.

The saw motor 104 (see FIGS. 1 and 2) drives a reciprocating output shaft 212. The blade clamp assembly 206 couples and secures the elongated saw blade 106 to the reciprocating output shaft 212. The blade clamp assembly 206 functions as a chuck to receive and lock the elongated saw blade 106 to the reciprocating output shaft 212. In the exemplary embodiment shown, the lever mechanism for operating the chuck is not shown so that some details of the chuck may be visible. In operation, a typical chuck or blade clamp assembly 206 receives the blade tang (not shown) in a slotted fixture within the chuck and locks the blade tang in place with a pin or latch bolt (not shown) secured to the chuck that passes through a corresponding hole through the blade tang. FIG. 2 also illustrates that the elongated saw blade 106 emerges from the saw blade slot 214 at an angle of approximately four (4) degrees from the vertical. This angle may vary within a range of plus or minus four degrees relative to the nominal four degree angle. Thus, the saw blade 106 is positioned so that the teeth begin cutting into the uppermost edge of the workpiece 108 as it is moved into contact with the elongated saw blade 106.

The elongated saw blade 106 may be a standard reciprocating saw blade available from such manufacturers as Lenox or Milwaukee. One suitable saw blade is a Type 5689 metal cutting, 18 TPI (teeth per inch), bi-metal blade for cutting metal, manufactured by the Milwaukee company. Lenox manufactures a stainless steel cutting blade made of a cobalt/steel alloy that is very hard and holds its sharpness well. Lenox also manufactures a 10/14 TPI, carbide-tipped blade that readily cuts both steel and the EPS foam material. Other reciprocating saw blades intended for such applications as power hack saws or demolition blades may also be used. In the illustrated embodiment, the length of a typical elongated saw blade may be up to approximately 12 inches long, and may be 1 inch wide, 0.063 inches thick, and sufficient for panel thicknesses of 7-½ inches. However, the foregoing saw blade description should not be construed as limiting. The length, thickness and other characteristics of the saw blade required should be determined by and adjusted to the thickness and material of the workpiece. Elongated saw blades are available in a wide range of lengths, thicknesses, blade materials and tooth specifications.

Referring to FIG. 4, there is illustrated a pictorial view of details of one embodiment of a saw blade guide assembly including a guide block assembly and a cantilevered support arm 144 stabilized by a damper strap 142 attached to the support arm 144, for use with the embodiment of the powered reciprocating table saw of FIG. 1. In the perspective view of FIG. 4, only the center sections of the first and second intermediate cross members 130, 132 and the right main cross member 120 are shown. As in previous figures, some of the structures illustrated in FIG. 4 appeared in FIGS. 1, 2, and 3 and bear the same reference numbers. The mounting plate 110 is shown supported on the mounting plate supports 140 at each end of the mounting plate 110 (the perspective limits the view to only one of them). The mounting plate 110 may be secured to the mounting plate supports 140 by machine screws 410 at each corner of the mounting plate 110. The elongated blade 106 extends upward through the elongated blade opening 112 in the mounting plate 110 at a nominal angle of approximately four degrees from perpendicular to the mounting plate 110 and leaning toward the workpiece, as described herein above. The damper strap 142 extends vertically upward from the slot 114 in the mounting plate 100 The damper strap 142, which may be fabricated from the same steel alloy material as used for the elongated saw blade 106, may be attached to the underside of the mounting plate 110 by either rigid or resilient fasteners (not shown).

The damper strap 142 and the elongated blade 106 are disposed in the same plane that is also defined by the kerf made by the elongated saw blade 106 during a cutting operation. The forward edge 146 of the damper strap 142 may be beveled in the manner of a knife edge to facilitate the passage of the workpiece 108 past the damper strap 142 during a cutting operation. The damper strap 142 is attached at its upper end to a damper strap support 240 by a fastener 244 such as a machine screw. The damper strap support 240 may be attached to the side of support arm 144 by machine screws 242. In an alternate embodiment, the damper strap 142 may be used in a free-standing mode wherein its uppermost end is not attached to the support arm 144. This configuration may be used when the work piece is wider than a 4′×8′ panel that requires more than the nominal width of the work table frame and hence the removal of the support arm 144. In such an application, the blade guide assembly 220 to be described may be configured to be supported by the free end of the damper strap functioning as a support member for the blade guide assembly 220.

The support arm 144 may be adjustably attached to the right main cross member 120 by machine screws or other fastening devices or methods. It will be observed in FIG. 4 that the support arm 144 leans slightly toward the workpiece 108, facing in the same direction as the toothed edge of the elongated saw blade 106. This configuration of the support arm 144, and a support shaft 222 (that extends downward from the distal end of the support arm 144 to support the blade guide assembly 220 above the workpiece), are both disposed at the nominal four degree angle from vertical, in parallel with the elongated saw blade 106. The reason for this parallelism among these structures will become apparent in the description that follows.

Continuing with FIG. 4, the blade guide assembly 220 will be described. In the perspective view of FIG. 4, the vertical relationship between the mounting plate 110 (corresponding to the top surface of the work table frame 102 on which the work piece 108 slides during a cutting operation) and the bottom of the blade guide assembly 220 (which rests on the top surface of the workpiece 108 during a cutting operation) is shown somewhat compressed, without sacrificing any important detail of the structures illustrated. Further, in the description that follows, several structures will be described as being oriented in reference to the workpiece. While not shown in the figure, the workpiece is considered to be approaching from the right side of FIG. 4, to serve as a point of reference related to the function of the structural item being described.

The blade guide assembly 220 in the illustrated embodiment consists of five main parts: a blade guide support shaft 222, a blade guide frame 224, a floating guide block 226, an adjusting axle 228 and a workpiece shoe 230. Each of the five parts may be machined or fabricated of aluminum or steel or other suitable material. The blade guide frame 224 is configured as a rectangular block oriented parallel to the mounting plate 110 and is suspended at one end (to the left in FIG. 4) from the support shaft 222. The support shaft 222, having a round cross section as shown, passes through a bore in the (left) end of the blade guide frame 224 at the four degree angle relative to a perpendicular axis passing vertically through the blade guide frame 224, and is secured therein by a set screw 236. The lower end of the support shaft 222 is flush with the bottom surface of the blade guide frame 224. In the alternate embodiment described herein above using the damper strap 142 as a free-standing member for supporting the blade guide assembly 220, the bore or passage formed in the blade guide frame 224 would match the cross-section of the damper strap 142.

At the opposite end of the blade guide frame 224 is cut a wide, vertical slot for receiving one end of the floating guide block 226 therein. The floating guide block 226 is also configured as a rectangular block of material. The existence of the wide slot in the blade guide frame 224 forms a leg on each side of the blade guide frame 224 extending toward the workpiece The floating guide block 226 is pivotably suspended on the adjusting axle 228 between the legs of the blade guide frame 224. The adjusting axle 228 passes through one leg of the blade guide frame 224, through a first end of the floating guide block 226 and the other leg of the blade guide frame 224, in that order. At the second end of the floating guide block 226, opposite the first end, is provided a vertical slot to allow the passage of the elongated saw blade 106. The vertical slot in the floating guide block 226 is configured to restrain sideways displacement of the elongated saw blade 106 during a cutting operation. To facilitate the movement of the elongated saw blade 106 within the vertical slot in the end of the floating guide block 226, a teflon bearing 234 is provided on the interior faces of the vertical slot in the floating guide block 226. The teflon bearing 234 will be described further herein below.

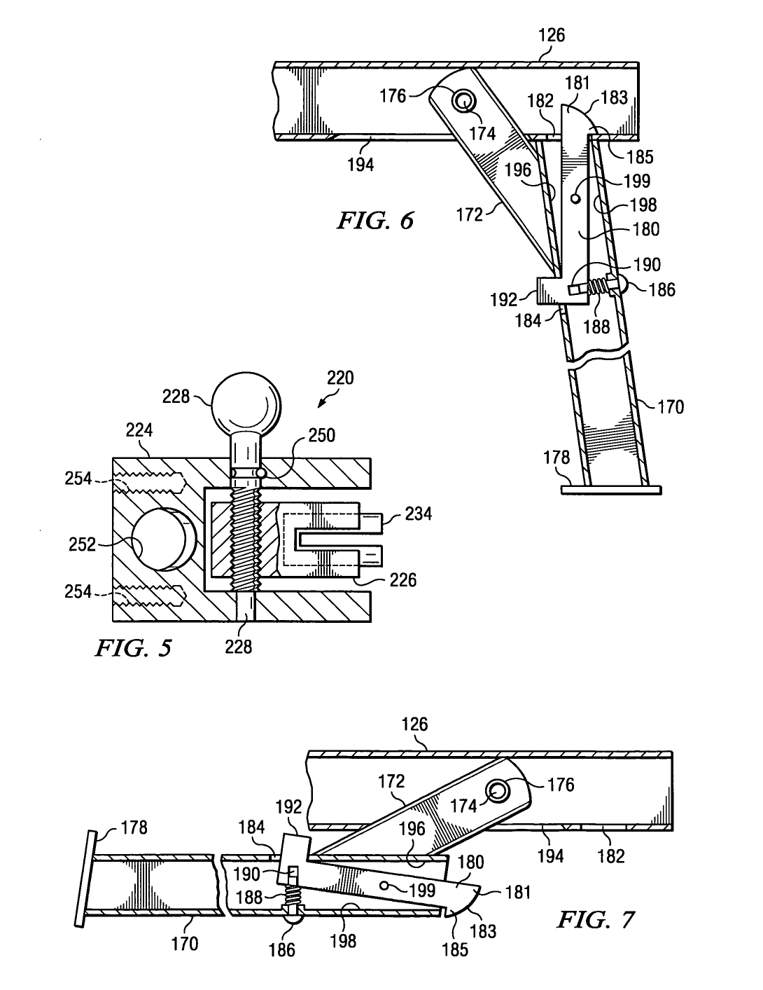

The adjusting axle 228 is threaded along the part of the adjusting axle that passes through the floating guide block 226 but not the parts of the adjusting axle that pass through the legs of the blade guide frame 224. Further, the adjusting axle 228 is retained in a fixed position relative to the blade guide frame 224 by a retaining pin 250 (see FIG. 5). The retaining pin 250 allows the adjusting axle to rotate while preventing movement along the longitudinal axis of the adjusting axle 228. Rotation of the adjusting axle causes the floating guide block 226 to move sideways within the wide slot of the blade guide frame 224, as will be described further in conjunction with FIG. 5.

Attached to the bottom surface of the blade guide frame 224 is a workpiece shoe 230, shaped somewhat like a pair of skiis oriented toward the workpiece 108. The workpiece shoe 230 is attached to the blade guide frame 224 by screws 232. The height of the blade guide frame 224 above the work table 102 is adjusted by positioning the support shaft 222 in the distal end of the support arm 144, and tightening the set screw 238 to fix the adjustment. The adjustment is made so that the workpiece shoe 230 will be almost in contact with the workpiece 108 as the workpiece 108 is moved along the upper surface of the work table frame 102 during a cutting operation. The workpiece shoe 230 serves to keep the workpiece in contact with the work table 102 during the cutting operation. Persons skilled in the art will understand that the blade guide assembly 220 illustrated herein is constructed to show the principles of its function of providing an adjustable component that will resist the displacement of the saw blade during cutting operations, and will further understand that the blade guide assembly may be implemented in a variety of ways while still embodying the inventive concept.

Referring to FIG. 5 there is illustrated a top plan view of one embodiment of a guide block assembly 220 for use with the embodiment of the powered reciprocating table saw of FIG. 4. Some of the structures illustrated in Figure appeared in FIG. 4 and bear the same reference numbers. The blade guide frame 224 is shown in the plan view, wherein the adjusting axle 228 passes through the side legs of the blade guide frame 224 and the floating guide block 226. The threaded portion of the adjusting axle is shown passing through the threaded hole in the first end of the floating guide block 226. The adjusting axle 228 is prevented from longitudinal movement due to the retaining pin 250 inserted through a hole in the blade guide frame 224 and a circumferential groove machined into the adjusting axle 228. The adjusting axle 228 may have a flattened head shaped for ease of grasping to rotate the adjusting axle 228 to adjust the lateral position of the floating guide block 226 relative to the elongated saw blade 106 passing through the vertical slot in the floating guide block 226. The correct adjustment is provided when the sides of the elongated saw blade 106 are equidistant from the bearing surfaces of the sides of the vertical slot in the floating guide block 226.

The teflon bearing 234 may be provided by installing a cylinder of the teflon material, slotted to a width slightly less than the width of the vertical slot provided in the floating guide block 226, in a longitudinal bore extending into the floating guide block 226 to a depth just beyond the depth of the vertical slot. The teflon cylinder is slightly longer than the depth of the bore into the floating guide block 226, but not so long that it would be contacted by the teeth of the elongated saw blade 106 during a cutting operation of the reciprocating table saw 100 described herein. The teflon material of the bearing 234 provides the bearing surfaces on both sides of the elongated saw blade 106 that reduce the friction between the elongated saw blade 106 and the floating guide block 226 if the elongated saw blade 106 should be displaced laterally when feeding the workpiece 108 into the reciprocating table saw 100. The floating guide block 226 also limits the rearward displacement of the elongated saw blade 106 in the ‘bottom’ of the vertical slot formed in the floating guide block 226 as the workpiece 108 is fed into the reciprocating table saw 100. A bearing (not shown) may be provided in the ‘bottom’ of the vertical slot in the floating guide block 226 for certain heavy duty applications, but is not considered as necessary as the teflon bearing 234 because the area of the surfaces that may be involved in the friction are much smaller.

Other features of the guide block assembly 220 shown in FIG. 5 include the hole 252, machined at an angle of approximately four degrees relative to a line normal to the plane of the drawing, in the blade guide frame 224 for receiving the support shaft 222. When the support shaft is positioned in the hole 252 it may be retained by any of several means known to persons skilled in the art such as the set screw 236 shown in FIG. 4 herein above. Also shown in FIG. 5 are a pair of tapped holes 254, which are provided for the machine screws used to attach the workpiece shoe 230 to the blade guide frame 224.

Previously, it was described that the support shaft 222 and the support arm 144 that supports the support shaft 222 are required to be disposed at the same forward angle of approximately four degrees relative to the line normal to the surface of the work table frame 102 as the tilt of the elongated saw blade 106. When making straight line cuts, as is the case with many of the cutting operations performed by the reciprocating table saw 100 of the present invention, the elongated saw blade 106 is tilted to facilitate the initial cut into the workpiece 108 as it is fed into contact with the elongated saw blade 106. In such applications, the support arm 144 and the support shaft 222 must be at the same angle to maintain the floating guide block 226 (and indeed the entire blade guide assembly 220) in the proper relationship with the elongated saw blade 106 as the blade guide assembly 220 is adjusted upward or downward to accommodate different thicknesses of the workpiece 108. In other applications, wherein the reciprocating table saw 100 is used for making curved cuts, in the manner of a band saw, the angle the elongated blade makes with the work table frame 102 may be approximately zero degrees from normal, i.e., perpendicular to the work table frame 102.

Referring to FIG. 6 there is illustrated a side view of a longitudinal section of an end of a side rail 126 of the work table frame 102 of the embodiment of the powered reciprocating table saw of FIG. 1 showing detail of one embodiment of a collapsible or folding leg assembly with the leg in an extended (or unfolded) position for supporting the work table. As noted previously herein, the extended leg 170 forms an angle of approximately 100 degrees relative to the work table frame 102. Other angles may be used to suit the particular application. The 100 degree angle is chosen for maximum stability without extending the legs too much beyond the corners of the work table frame 102. FIG. 7 illustrates the same structures as FIG. 6, except that the view in FIG. 7 is of the collapsible leg 170 shown in a collapsed or folded position. Therefore, the detailed description for FIGS. 6 and 7 is the same for each figure. Some of the structures illustrated in FIGS. 6 and 7 appeared in FIG. 1, and bear the same reference numbers. In this embodiment, the side rails 124, 126 of the work table frame 102 are fabricated of tubular aluminum stock to enable the operation of the collapsible leg configuration shown in FIG. 6.

In FIG. 6, an end portion of the side rail 126 is shown with a leg 170 attached thereto. Extending from the leg 170 at an acute angle of approximately 30 degrees toward the side rail 126 is a rigid brace 172 formed of a shallow channel stock of the same material as the leg 170. The rigid brace 172 is fixedly attached to the leg 170 near the upper end of the leg 170 and on the side of the leg 170 that faces the opposite end of the side rail 126. The opposite (upper) end of the rigid brace 172 is disposed through one end of an opening 194 cut into the bottom side of the side rail 126. The upper end of the rigid brace 172 is secured to the inside of the side rail 126 by a laterally disposed pivot pin 174 through the side walls of the side rail 126 and a bushing 176 in the upper end of the rigid brace 172. The opening 194 in the bottom side of the side rail is long enough to accommodate the swing of the rigid brace 172 through an arc of approximately 100 degrees when the leg 170 is pivoted about the pivot pin 174 to a collapsed or folded position approximately parallel to the side rail 126 (see FIG. 7). The collapsed legs 170 may be held against the work table frame 102 with elastic straps (not shown) or retaining devices attached to the work table frame 102 or the legs 170.

Installed within the upper portion of the leg 170 is a pivoting latch arm 180. The latch arm 180 pivots on a pivot pin 194 passing through a midpoint of the latch arm 180 and through the leg 170 and secured to the side wall thereof. The latch arm 180 is configured as a pawl 181 at a first end of the latch arm 180 that extends through a locking slot 182 cut into the bottom side of the side rail 126. The locking slot 182 is just large enough to feed the pawl 181 at the first end of the latch arm 180 through the slot. The pawl 181 includes a radius 183 that functions as a ramp and a stepped pawl tooth 185 to engage the locking slot 182 in the side rail 126 when the leg 170 is brought in proximity to the locking slot 182 in the bottom side of the side rail 126 to engage the pawl 181 in the locking slot 182. As the pawl 181 at the upper end of the latch arm 180 becomes in contact with the edge of the locking slot 182, the ramp 183 causes the latch arm 180 to pivot about the pivot pin 194, compressing a spring 188 (to be described) at the opposite end of the latch arm 180, until the stepped tooth 185 of the pawl 181 on the latch arm 180 rides over the edge of the locking slot 182 and engages the inside surface of the side rail 126 at the end of the locking slot 182.

The second end of the latch arm 180 opposite from the first end is biased against a first inside wall 196 of the leg 170 by a spring 188 bearing against a well 190 in the second, lower end of the latch arm 180. The spring 188 is supported over a pin 186 attached to a second inside wall 198 of the leg 170. Under the tension exerted by the spring 188 in its extended position, the second, lower end of the latch arm 180 is pressed into contact with the first inside wall 196 of the leg 170, and the pawl tooth 185 at the upper end of the latch arm 180 engages the edge of the locking slot 182 in the bottom side of the side rail 126. The lower end of the latch arm 180 includes an extension button 192 that protrudes from an opening 184 in the first inside wall 196 of the leg 170. To disengage the pawl 181 from the locking slot 182, all that is required is to press the extension button 192 enough to disengage the pawl tooth 185 at the upper end of the latch arm from the locking slot 182. When the pawl tooth 185 is thus disengaged, the leg 170 may be pivoted into a folded position alongside the work table frame 102 for storage or transport, as shown in the view of FIG. 7.

While the invention has been shown in only one of its forms, it is not thus limited but is susceptible to various changes and modifications without departing from the spirit thereof. For example, a blade guide assembly may be supported by the damper strap member instead of the cantilevered support arm. While the damper strap provides improved support for the cantilevered support arm during straight cuts, the damper strap may be removed for cutting along curved lines. The work table frame may be covered with a thin, rigid sheet of material to provide a broad, smooth work surface by securing it to the work table frame and providing an elongated opening for the saw blade to match the one in the mounting plate.

Persons skilled in the art will further appreciate that the blade guide assembly may be implemented in a variety of ways without departing from the spirit of the invention. Likewise, the folding legs may be configured in several different ways from the illustrative embodiment described herein above, including the provision of latches to retain the legs in a folded position during transport. Other improvements and features are certainly feasible, such as a variable speed saw motor, adjustable blade angle, a storage spool for the power cord, etc.

While the illustrated embodiment is shown using a standard, off-the-shelf reciprocating saw, the invention is not limited to the particular reciprocating saw shown. Moreover, another contemplated embodiment utilizes a custom saw motor configured such that the motor, transmission and motor mount may be integrated together in a more compact design that minimizes the moment arm formed by these components to reduce vibration and improve stability. Further, the motor mount may be configured for a quick-release mounting without the use of tools for ease of set up and take down at the job site. Controls for the saw motor may be mounted on a panel convenient to the saw operator.

The foregoing examples illustrate the variety of configurations possible in the present invention without departing from the scope of the invention and the utility it provides, as set forth in the following claims.

1. A powered reciprocating table saw, comprising:
a work table, having first and second sides, for supporting a workpiece on the first side of the work table and having a mounting plate disposed proximate an intermediate location of the work table wherein a first surface of the mounting plate is coplanar with the first side of the work table;
a saw motor oriented vertically and supported beneath the work table from a second surface of the mounting plate, the saw motor having a housing, a reciprocating output shaft extending upward from the housing, and blade clamping means disposed on the distal end of the reciprocating output shaft; and
an elongated saw blade having first and second ends, retained at the first end in the blade clamping means of the saw motor and positioned to pass through and move reciprocatingly along an axis of reciprocation within a blade opening approximately centrally disposed in the mounting plate of the work table wherein the saw blade extends upward and substantially beyond the first side of the work table for cutting the workpiece during operation.

2. The table saw of claim 1, further comprising:
a motor mount disposed between and attached to the saw motor housing and the second surface of the mounting plate for supporting the saw motor from the second surface of the mounting plate wherein the axis of reciprocation of the output shaft is aligned with the blade opening in the mounting plate and disposed at an angle of approximately four degrees from normal to the first side of the work table.

3. The table saw of claim 2, wherein the angle of the axis of reciprocation may vary within the range defined by an angle of four degrees from normal to the first side of the work table, within a range of plus or minus four degrees.

4. The table saw of claim 2, wherein the angle of reciprocation may be adjustable within the range of plus or minus four degrees relative to approximately four degrees from normal to the first side of the work table.

5. The table saw of claim 1, further comprising:
a blade guide assembly supported by means attached to the work table and spaced away from the first side of the work table adjacent the axis of reciprocation and embracing the second end of the saw blade to limit sideways displacement of the second end of the saw blade relative to the axis of reciprocation while cutting the workpiece.

6. The table saw of claim 1, wherein the work table comprises:
a frame constructed of first and second parallel side rails secured to opposite ends of a plurality of parallel cross members disposed therebetween, wherein first and second cross members disposed at an intermediate position along the first and second side rails are spaced a predetermined distance apart for receiving the mounting plate therebetween; and
the mounting plate having a top surface disposed in the plane of the first side of the work table and supported between the first and second cross members, the mounting plate configured for supporting the saw motor from the second side of the mounting plate.

7. The table saw of claim 6, wherein the work table further comprises:
first and second fence track rails disposed respectively along an outer side of the first and second parallel side rails of the work table frame for receiving and guiding a table saw fence thereon; and
a table saw fence having a first and a second end configured for sliding along and being secured respectively to the first and second fence track rails and further having a head end equipped with a clamping device for securing the first and second ends of the fence to the respective first and second fence track rails.

8. The table saw of claim 1, wherein the work table includes a collapsible leg, pivotally attached to each corner of the work table, the collapsible leg having an upper end and a lower end.

9. The work table of claim 8, wherein each collapsible leg pivots about a pin through a side rail of the work table and a first end of a rigid brace, the rigid brace fixed at a second end at a predetermined acute angle to a near side of the upper end of the collapsible leg, the collapsible leg pivoting from a collapsed position against and along a lower side of the side rail of the work table to an extended position extending downward and at an angle approximately 100 degrees from the collapsed position, wherein the upper end of the collapsible leg is secured to the side rail in the extended position by a pivoting, spring-biased latching pawl having a hooked end, the latching pawl disposed within and the hooked end slightly protruding from the upper end of the collapsible leg, when the upper end of the collapsible leg is moved toward and against the side rail into the extended position, whereby the protruding, hooked end of the latching pawl is caused to enter a corresponding opening in the lower side of the side rail of the work table and snap into a locked position under the tension of a biasing spring that provides the spring bias to the latching pawl.

10. The table saw of claim 8, wherein the pivoting, spring-biased latching pawl is released to allow collapse of the collapsible leg by rotating the latching pawl about its pivot against the spring tension of the biasing spring to disengage the hooked end of the latching pawl from the corresponding opening in the lower side of the side rail of the work table.

11. The table saw of claim 1, wherein the work table includes folding leg means attached to the second side of the work table.

12. The table saw of claim 1, wherein the work table is adapted to being supported upon a pair of sawhorses positioned beneath the second side of the work table.

13. The table saw of claim 1, wherein the work table further comprises a work surface formed from a thin sheet of rigid material for covering the first side of the work table including the mounting plate and having a blade opening formed therethrough that coincides with the blade opening in the mounting plate, wherein the work surface is secured to the first and second side rails of the work table with individual fasteners at a plurality of locations.

14. The table saw of claim 1, wherein the work table further comprises:
an array of mounting holes in the mounting plate and proximate the blade opening for attaching a motor mount to the second side of the mounting plate.

15. The table saw of claim 14, wherein a first mounting hole defines a pivot point and the remaining mounting holes depart from a circular shape to allow for adjustment of the motor mount relative to the blade opening.

16. The table saw of claim 14, wherein the mounting holes are countersunk to receive flat head or pan head screws for securing the motor mount to the mounting plate.

17. The table saw of claim 1, wherein the blade opening in the mounting plate is an elongated slot dimensioned to freely receive an elongated saw blade therethrough.

18. The table saw of claim 1, wherein the first side of the work table defines an equivalent plane area sufficient to support a workpiece at least four feet wide.

19. The table saw of claim 1, wherein the second side of the mounting plate includes a motor mount receptacle and a cammed lever latch proximate the blade opening in the mounting plate for securing a motor mount in snap-in fashion to the second side of the mounting plate without the use of tools.

20. The table saw of claim 1, wherein the housing of the saw motor comprises mounting means for attaching the saw motor to the second side of the mounting plate such that the elongated saw blade clamped to the distal end of the reciprocating output shaft of the saw motor is aligned to pass through the blade opening in the mounting plate.

21. The table saw of claim 1, wherein the reciprocating output shaft has a reciprocating stroke of at least one-half inch

22. The table saw of claim 1, wherein the blade clamping means secures the first end of the elongated blade to the distal end of the reciprocating output shaft of the saw motor.

23. The table saw of claim 1, wherein the blade clamping means secures the blade in a chuck actuated by a lever mechanism.

24. The table saw of claim 1, wherein the blade clamping means secures the blade in a chuck actuated by a rotating collar mechanism.

25. The table saw of claim 1, wherein the elongated blade comprises a length-to-width ratio of at least ten-to-one and teeth adapted to cutting sheet metal and a foamed plastic material.

26. The table saw of claim 2, wherein the motor mount is secured to the mounting plate using one or more machine screws.

27. The table saw of claim 2, wherein the motor mount is secured to the mounting plate using a quick release mechanism.

28. The table saw of claim 27, wherein the quick release mechanism comprises:
a foot disposed on the second side of the mounting plate for receiving a corresponding shoe portion of the motor mount;
a portion of the motor mount configured as a shoe for receiving the foot disposed on the second side of the mounting plate proximate the blade opening;
a hand-operated locking device for securing the foot within the shoe portion of the motor mount, the locking device selected from the group consisting of a cam lock, an over center lock, a self-locking nut, a spring-biased lock and a thumb screw.

29. The table saw of claim 27, wherein the quick release mechanism comprises:
a portion of the motor mount configured as a foot for being retained within a shoe disposed on the second side of the mounting plate proximate the blade opening;
a shoe disposed on the second side of the mounting plate for receiving the foot portion of the motor mount; and
a hand-operated locking device for securing the foot portion of the motor mount within the shoe, selected from the group consisting of a cam lock, an over center lock, a self-locking nut, a spring-biased lock and a thumb screw.

30. The table saw of claim 2, wherein the motor mount is secured to the saw motor housing using one or more machine screws.

31. The table saw of claim 2, wherein the motor mount comprises a box-like adapter, having a first face and an opposing second face approximately parallel to the first face, wherein the first face has a corresponding elongated blade opening therethrough and the second face has a corresponding opening for passage of the reciprocating output shaft therethrough and wherein the first face is adapted for attaching the motor mount to the second side of the mounting plate of the work table and the second face is adapted to attaching to the saw motor housing such that the reciprocating blade axis is disposed at a predetermined angle relative to the first side of the work table for cutting the workpiece as the workpiece is moved past the elongated saw blade when the saw motor is attached to the mounting plate via the motor mount.

32. The table saw of claim 31, wherein the motor mount is dimensioned to enclose the blade clamping means between the first and second faces of the motor mount and further to allow for the reciprocating motion of the blade clamping means attached to the distal end of the reciprocating output shaft.

33. The table saw of claim 31, wherein the predetermined angle relative to the first side of the work table is approximately four degrees from normal to the first side of the work table plus or minus four degrees.

34. The table saw of claim 31, wherein the motor mount is a casting or a weldment fabricated of a rigid, high-strength material.

35. The table saw of claim 5, wherein the blade guide is slidably supported on a support shaft suspended from a cantilevered support arm attached to an edge of the work table and disposed to one side of a path followed by the workpiece during sawing.

36. The table saw of claim 5, wherein the blade guide is slidably adjustable along a support shaft disposed parallel to the reciprocating axis of the elongated blade, wherein the blade guide remains in position relative to the elongated blade when the blade guide height is adjusted for different thicknesses of the workpiece.

37. The table saw of claim 5, wherein the blade guide is supported from a blade-shaped member attached to the work table, and disposed in the same plane as the elongated blade and rearward of the elongated blade, such that the blade-shaped member occupies the saw kerf of the workpiece during operation.

38. The table saw of claim 37, wherein the blade-shaped member attached to the work table is disposed parallel to the reciprocating axis of the elongated blade, wherein the blade guide remains in position relative to the elongated blade when the blade guide height is adjusted for different thicknesses of the workpiece.

39. The table saw of claim 5, wherein the blade guide assembly comprises:
a rectangular guide block, having a first and second end and a vertical slot disposed at the first end to receive a substantial portion of the width of the second end of the elongated saw blade therein, wherein first and second side walls of the slot, being spaced apart approximately twice the thickness of the elongated saw blade and substantially parallel thereto, limit the sideways displacement of the elongated saw blade during a cutting operation on the workpiece; and
a U-shaped blade guide frame having first and second legs for supporting the rectangular guide block therebetween, the rectangular guide block being retained on an adjustment axle passing laterally through the first and second legs of the blade guide frame and through a threaded hole disposed laterally through the rectangular guide block between the vertical slot and the second end of the rectangular guide block, wherein the portion of the axle disposed between the first and second legs of the blade guide frame is threaded such that rotation of the axle in either direction causes lateral movement of the rectangular guide block to laterally center the elongated saw blade in the vertical slot of the rectangular guide block.

40. The table saw of claim 39, wherein the rectangular guide block further comprises a self-lubricating bearing surface disposed on each of the first and second side walls of the vertical slot.

41. The table saw of claim 40, wherein the self-lubricating bearing surface is provided by a teflon face disposed in each of the first and second side walls of the vertical slot.

42. The table saw of claim 39, wherein the adjustment axle includes at least one end configured to provide rotation of the axle in either direction in the blade guide frame for adjusting the lateral position of the rectangular blade guide between the first and second legs of the blade guide frame.

43. The table saw of claim 39, wherein the blade guide frame is adjustably supported on a vertically oriented, cylindrical support shaft suspended, from a support member attached to the work table, above the first side of the work table and proximate a rearward edge of the elongated blade, wherein the blade guide frame is provided with vertical and polar angle adjustments to position the rectangular guide block in a guiding relationship that receives the elongated saw blade within the vertical slot and limits the sideways displacement of the elongated saw blade during a cutting operation on the workpiece.

44. The table saw of claim 39, wherein the blade guide frame includes a bifurcated, horizontally-disposed workpiece shoe extending from a lower surface of the blade guide frame to a disposition on either side of and beyond the width of the elongated saw blade for holding downward the workpiece against the first side of the worktable during a sawing operation.

45. The table saw of claim 5, wherein the blade guide assembly comprises a U-shaped body having a throat and first and second legs enclosing the elongated blade proximate both sides thereof between the first and second legs, a rearward edge of the elongated blade disposed in the throat of the U-shaped body wherein first and second blade-guiding dowell pins disposed along a common axis perpendicular to the elongated blade and passing laterally through the first and second legs of the blade guide and in juxtaposition proximate each side of the elongated blade and wherein each dowell pin is adjustably supported in one respective leg of the U-shaped body such that the elongated blade passes between opposing faces of the first and second blade-guiding dowell pins to restrain the elongated blade from being displaced sideways as the workpiece is being sawed.

46. The table saw of claim 45, wherein the blade guide further comprises a back stop bar member disposed laterally across and within the throat of the U-shaped body to restrain the rearward edge of the elongated blade from being displaced rearward as the workpiece is being sawed.

47. The table saw of claim 5, wherein the blade guide comprises a U-shaped body enclosing the elongated blade at both sides and a rearward edge of the elongated blade, the U-shaped body further including a bearing surface disposed within each side of the U-shaped body in juxtaposition proximate each side of the elongated blade such that the elongated blade passes between opposing faces of the bearing surface to restrain the elongated blade from being displaced sideways as the workpiece is being sawed.
